(19) United States
(12) Patent Application Publication
(10) Pub. No.: US 2024/0322652 A1
(43) Pub. Date: Sep. 26, 2024

(54) POWER GENERATOR COOLER PERFORMANCE MONITORING DEVICE

(71) Applicant: TOSHIBA ENERGY SYSTEMS & SOLUTIONS CORPORATION, Kawasaki-shi (JP)

(72) Inventors: Yasuo KABATA, Yokohama Kanagawa (JP); Masafumi FUJITA, Yokohama Kanagawa (JP); Yuichiro GUNJI, Yokohama Kanagawa (JP); Hirotada ENDO, Ota Tokyo (JP); Koji ANDO, Yokohama Kanagawa (JP)

(73) Assignee: TOSHIBA ENERGY SYSTEMS & SOLUTIONS CORPORATION, Kawasaki-shi (JP)

(21) Appl. No.: 18/404,432

(22) Filed: Jan. 4, 2024

(30) Foreign Application Priority Data
Mar. 22, 2023 (JP) 2023-045626

(51) Int. Cl. H02K 9/24; H02K 9/08

(52) U.S. Cl. CPC H02K 9/24; H02K 9/08

(57) ABSTRACT

According to an embodiment, a power generator cooler performance monitoring device comprises: a cooler characteristic calculator configured to calculate a fouling degree ξ of a cooling pipe of the power generator cooler as a past fouling degree-related information based on information measured regarding a power generator; a prediction calculator configured to calculate the fouling degree ξ in a future as a future fouling degree-related information based on the past fouling degree-related information; and an image data generator configured to generate display information based on the past fouling degree-related information and the future fouling degree-related information for display.

### CROSS-REFERENCE TO RELATED APPLICATION

This application is based upon and claims the benefit of priority from Japanese Patent Application No. 2023-045626 filed on Mar. 22, 2023, the entire content of which is incorporated herein by reference.

### FIELD

Embodiments of the present invention relate to a power generator cooler performance monitoring device.

### BACKGROUND

While in operation, a power generator of a power station suffers losses such as an iron loss including a hysteresis loss and an eddy-current loss in its stator and rotor cores and such as a copper loss in its stator and rotor coils. Inside the power generator, a cooling gas, for example, a hydrogen gas, is filled, and while the power generator is in operation, the cooling gas circulates in its interior to cool the interior. Further, in some cases, cooling water is passed in the stator coil to directly cool the stator coil.

The cooling gas is cooled by being heat-exchanged with the cooling water in a power generator cooler. Specifically, heat generated by the iron loss, the copper loss, and so on in the power generator is removed by the cooling gas and moves to the cooling water side in the power generator cooler. The heat which has moved to the cooling water side further moves to a final heat sink. Examples of the final heat sink include seawater or river water in a final cooler or the atmosphere in a cooling tower.

In the power generator gas cooler, due to the quality condition of the used cooling water, fouling accumulates on a cooling pipe inner wall, and fouling adheres to a fin of the cooling pipe to increase thermal resistance (called a fouling factor) between the cooling gas and the cooling water. This constitutes the main factor causing deterioration in the heat exchange performance of the cooler. Not only the simple fouling on a heat transfer surface but also the corrosion of the cooling pipe or the mixture of the hydrogen gas into the cooling water through the cooling pipe also deteriorates the heat exchange performance of the cooler. This causes a temperature rise of the cooling gas or an increase in the amount of the cooling water, and the operation is finally stopped because of the high temperature of the cooling gas or the cooling water.

To remedy the fouling degree, it is necessary to stop the power generator, open the power generator cooler, and clean the inner and outer surfaces of the cooling pipe. Accordingly, remedying the fouling degree requires a due period and also increases a regular inspection cost, and thus an appropriate time has to be selected for the remedy.

### BRIEF DESCRIPTION OF THE DRAWINGS

FIG. 1 is a conceptual vertical sectional view illustrating a configuration example of a power generator that is to be monitored by a power generator cooler performance monitoring device according to an embodiment.

FIG. 2 is a block diagram illustrating the configuration of the power generator cooler performance monitoring device according to the embodiment.

FIG. 3 is a first flowchart illustrating a detailed flow of a calculation step by a loss and interior gas state quantity calculator of the power generator cooler performance monitoring device according to the embodiment.

FIG. 4 is a second flowchart illustrating a detailed flow of the calculation step by the loss and interior gas state quantity calculator of the power generator cooler performance monitoring device according to the embodiment.

FIG. 5 is a flowchart illustrating a detailed flow of an calculation step by a cooler characteristic calculator of the power generator cooler performance monitoring device according to the embodiment.

FIG. 6 is a first view illustrating an example of a calculation-target state quantity identification screen 132a for the identification of a calculation-target state quantity in a method of the power generator cooler performance monitoring device according to the embodiment.

FIG. 7 is a second chart illustrating the example of the calculation-target state quantity identification screen 132a for the identification of the calculation-target state quantity in the method of the power generator cooler performance monitoring device according to the embodiment.

FIG. 8 is a third chart illustrating the example of the calculation-target state quantity identification screen 132a for the identification of the calculation-target state quantity in the method of the power generator cooler performance monitoring device according to the embodiment.

FIG. 9 is a flowchart illustrating the flow of a process by the power generator cooler performance monitoring device according to the embodiment.

FIG. 10 is a screen view illustrating an example of an initial operation image displayed by HMI of the power generator cooler performance monitoring device according to the embodiment.

FIG. 11 is a screen view illustrating an example of a latest record image displayed by the HMI of the power generator cooler performance monitoring device according to the embodiment.

FIG. 12 is a screen view illustrating an example of a first verification result image displayed by the HMI of the power generator cooler performance monitoring device according to the embodiment.

FIG. 13 is a screen view illustrating an example of a second verification result image displayed by the HMI of the power generator cooler performance monitoring device according to the embodiment.

### DETAILED DESCRIPTION

A problem to be solved by the present invention is to provide a power generator cooler performance monitoring device capable of recognizing, in time series, past-to-present cooling pipe fouling degrees of a power generator cooler, which are calculated based on measured information, and predicted future cooling pipe fouling degrees.

To attain the above object, a power generator cooler performance monitoring device according to this embodiment includes: a power generator cooler performance monitoring device for a power generator, the device comprising an image data generator configured to generate display information for displaying: past fouling degree-related information regarding past-to-present fouling degrees of a power generator cooler cooling pipe from the past to the present calculated based on information regarding the power generator; and future fouling degree-related information indicating information regarding a future fouling degree of the power generator cooling pipe in the future based on the past fouling degree-related information.

The power generator cooler performance monitoring device according to the embodiment of the present invention will be hereinafter described with reference to the drawings. Here, identical or similar parts are denoted by common reference signs and a redundant description thereof will be omitted.

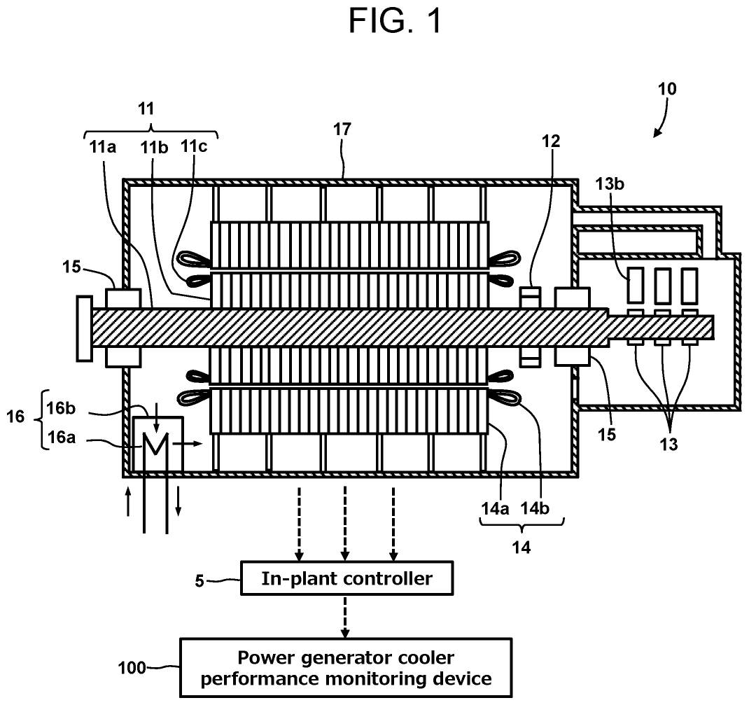

FIG. 1 is a conceptual vertical sectional view illustrating a configuration example of a power generator 10 to be monitored by the power generator cooler performance monitoring device 100 according to the embodiment.

The power generator 10 has a rotor 11, a fan 12 attached to the rotor 11, collectors 13, a stator 14, shaft bearings 15, a power generator cooler 16, and a frame 17.

The rotor 11 has a rotor shaft 11a extending in the rotation axis direction and having axial-direction ends rotatably supported by the shaft bearings 15, a rotor core 11b attached to the radially outer side of the rotor shaft 11a, and a field coil 11c wound around the rotor core 11b. Note that the rotor shaft 11a and the rotor core 11b may be integrally manufactured. At an end portion of the rotor shaft 11a, the collectors 13 are attached for respective phases to face stationary-side brushes 13b in order to supply a direct current to the field coil 11c. Note that the power generator 10 may be of a brushless type, though not illustrated, in which a rotating part of an exciter and a rotary commutator are attached to the rotor shaft 11a, and a stationary part of the exciter is arranged on the radially outer side of the rotating part of the exciter to face the rotating part.

The stator 14 has a cylindrical stator core 14a arranged on the radially outer side of the rotor core 11b with a gap therebetween and an armature coil 14b which is a stator coil wound around the stator core 14a.

The frame 17 houses the stator 14, the collectors 13, the rotor core 11b, and so on. In the frame 17, heat is generated due to iron losses in the rotor core 11b, the stator core 14a, and so on and copper losses in the field coil 11, the armature coil 14b, and so on. To remove the heat generated by the heat generating parts, a cooling gas, for example, a hydrogen gas, is sealingly filled in the frame 17. Further, to circulate the cooling gas in the frame 17, the fan 12 is attached to the rotor shaft 11a and rotates with the rotor shaft 11a, thereby forming a circulation head. In FIG. 1, a detailed configuration for the circulation of the cooling gas in the interior (in the frame 17) is omitted.

To remove the heat from the cooling gas, the power generator cooler 16 is provided in a circulation channel of the cooling gas. FIG. 1 illustrates an example where the power generator cooler 16 is in the frame 17, but it may be outside the frame 17. Further, though only one cooler is illustrated in FIG. 1, a plurality of power generator coolers may be installed. The power generator cooler 16 has a finned-cooling pipe 16a in its casing 16b and heat-exchanges the cooling gas passing on the outer side of the cooling pipe 16a in the casing 16b with cooling water passing in the cooling pipe 16a to cool the cooling gas.

State quantities concerning the power generator 10 are measured by not-illustrated respective detectors, and their signals are captured by a in-plant controller 5 such as, for example, DCS (Distributed Control System). Note that the state quantities to be measured may differ depending on each power plant.

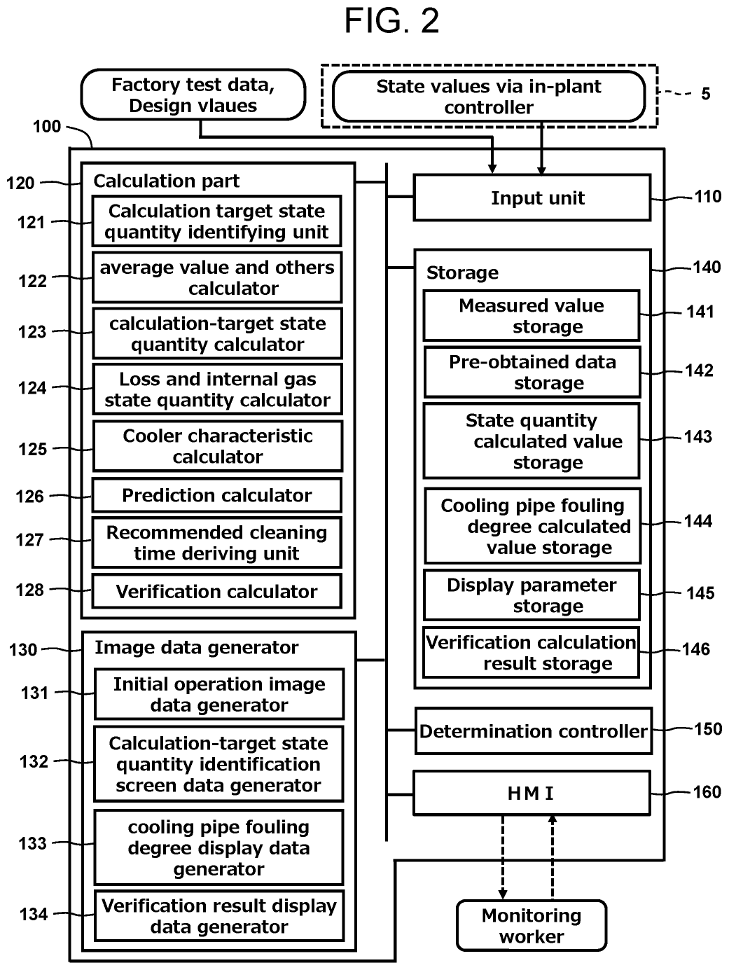

The power generator cooler performance monitoring device 100 obtains information necessary for the power generator cooler performance monitoring from the in-plant controller 5 and also receives other necessary information as an external input. FIG. 2 is a block diagram illustrating the configuration of the power generator cooler performance monitoring device 100 according to the embodiment.

The power generator cooler performance monitoring device 100 includes an input unit 110, an calculation part 120, an image data generator 130, a storage 140, a determination controller 150, and a human machine interface (HMI) 160. The power generator cooler performance monitoring device 100 is, for example, a computer system but may be an assembly of the devices.

The input unit 110 receives and obtains state quantities of the power generator 10 as measured state quantities through the in-plant controller 5 such as DCS and pre-obtained data such as factory test data and design values. Note that even if the detection signals of the detectors are analog signals, the state quantities are digital values resulting from the conversion of the analog signals into digital signals in the in-plant controller 5. It is assumed that the pre-obtained data are also digital values. In the case where these values are analog values, they are converted to digital signals by a not-illustrated AD converter. If the factory test data and the design data cannot be obtained because a manufacturing maker of a target power generator is different, the pre-obtained data may include inferred values calculated with reference to other plants or the like.

The state quantities include an electric power value of the power generator 10. The electric power value here means both active power (MW) and reactive power (MVar), or means apparent power (MVA). The sum of the active power (MW) and the reactive power (MVar), or the apparent power (MVA) corresponds to a current value of the armature coil 14b, that is, thermal load. In the case where not both the active power (MW) and the reactive power (MVar) are present, the electric power value may be only the active power (MW). In the below, they are collectively called an electric power value P_{GEN}.

The calculation part 120 performs calculations up to actual operation-based calculation of a fouling degree & of the inner and outer surfaces of the cooling pipe 16a which degree ξ is an index of heat transfer performance of the power generator cooler 16, a prediction calculation of the fouling degrees ξ, and the verification of the calculations. The calculation part 120 has a calculation-target state quantity identifying unit 121, an average value and others calculator 122, a calculation-target state quantity calculator 123, a loss and internal gas state quantity calculator 124, a cooler characteristic calculator 125, a prediction calculator 126, a recommended cleaning time deriving unit 127, and a verification calculator 128.

Here, the fouling degree ξ is defined as a ratio equal to a heat exchange duty P_{COOL} of the power generator cooler 16 calculated on the assumption that the cooling pipe 16 has no fouling on the inner surface, divided by heat removed by the power generator cooler 16 (gas cooler input heat amount P_{LOSS}). If their values are equal, the fouling degree ξ is 1. Further, if the cooling pipe 16a has fouling on the inner surface, the fouling degree ξ of the inner surface of the cooling pipe 16a is a value larger than 1. In the below, the fouling degree ξ will be expressed as “the fouling degree ξ of the inner surface of the cooling pipe 16a”, but the fouling degree ξ defined here is a comprehensive index indicating not only the simple fouling of a heat transfer surface but also the corrosion of the cooling pipe or deterioration in heat exchange performance due to the mixture of the hydrogen gas to the cooling water through the cooling pipe.

The calculation-target state quantity identifying unit 121 checks and identifies state quantities not included in the state quantities that the input unit 110 receives through the in-plant controller 5 of the plant to which the present embodiment is applied, that is, identifies calculation-target state quantities out of state quantities necessary for the standard calculations up to the calculation of the fouling degree ξ in a case where further state quantity is necessary for calculation of the cooling pipe fouling degree ξ. In other word, in a case where the measured state quantities and the pre-obtained data received by the input unit 110 are insufficient for calculation of the cooling pipe fouling degree and missing information for the calculation is present, the missing information to be calculated or estimated is identified as the calculation-target state quantities to be added.

The average value and others calculator 122 performs averaging of the state quantities received by the input unit 110. Specifically, it performs time-averaging of the state quantities received by the input unit 110 and calculates time average values. In the time-averaging, a moving average of a predetermined number N of state quantities or a moving average in an averaging time width Δt which is a predetermined time width including the predetermined number of state quantities may be calculated, or an average value of the predetermined number N of state quantities or an average value in each segment corresponding to the predetermined averaging time width Δt may be calculated.

The HMI 160 receives the predetermined number N of state quantities or the predetermined averaging time width Δt (hereinafter, collectively referred to as “the predetermined number N of state quantities”) as an external input of an initial condition as will be described later. Further, the average value and others calculator 122 calculates, regarding the predetermined number N of state quantities, a gas temperature width ΔTg equal to a cooler inlet gas temperature T_{I} of the power generator cooler 16 from which a cooler outlet gas temperature T_{O} is subtracted and a cooling water temperature width ΔTw equal to a cooler cooling water outlet temperature T_{wout} from which a cooler cooling water inlet temperature T_{win} is subtracted.

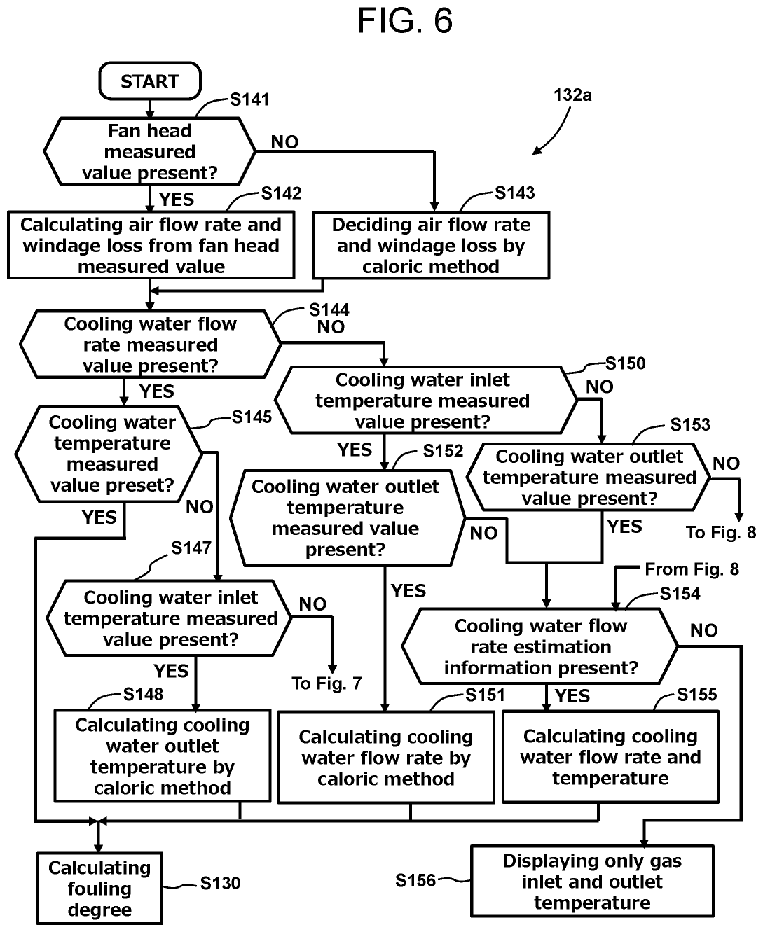

The calculation-target state quantity calculator 123 calculates or estimates calculation-target state quantities. Details will be described later with reference to FIG. 6 to FIG. 8. As the calculation-target state quantity calculator 123 calculates calculation-target state quantities as missing information to be added, the calculation-target state quantity calculator is also referred to as an adding calculator.

The loss and internal gas state quantity calculator 124 calculates losses which will be heat generation sources in the power generator and state quantities of the internal gas, based on the state quantities and the pre-obtained data received by the input unit 110 or calculated by the calculation-target state quantity calculator 123.

Based on information regarding the power generator including the measured state quantities, calculation-target state quantities and the pre-obtained data concerning the power generator cooler 16, the cooler characteristic calculator 125 calculates an equivalent thermal transmittance Km and a heat exchange duty P_{COOL} of the power generator cooler 16 and further calculates the fouling degree ξ of the inner and outer surfaces of the cooling pipe 16a.

The prediction calculator 126 calculates a fouling degree ξ that the cooling pipe 16a will have later than the present (in the future), based on the fouling degree ξ information stored in the cooling pipe fouling degree calculated value storage 144. These pieces of information function as past fouling degree-related information. Specifically, the prediction calculator 126 first calculates an increase rate of the fouling degree ξ fouling degree ξ/month) every day from effective data in a predetermined period (for example, twelve months) up to the present. The results are stored in the cooling pipe fouling degree calculated value storage 144. Next, the prediction calculator 126 derives the maximum increase rate among the increase rates in the predetermined period (for example, twelve months) which are stored in the cooling pipe fouling degree calculated value storage 144 and calculates a future value of the fouling degree ξ assuming that the fouling degree ξ increases with this maximum increase rate. These pieces of information function as future fouling degree-related information. A cooling pipe fouling degree display data generator 133 generates image data for this future performance deterioration prediction line that is to be displayed by the HMI 160.

The recommended cleaning time deriving unit 127 calculates a point in time when a fouling degree threshold value ξth is reached, from the performance deterioration prediction line derived by the prediction calculator 126. A recommended cleaning time is derived based on a future increase prospect of the fouling degree ξ and a value of a cleaning recommendation level ξ_{R} stored inside. Further, the recommended cleaning time deriving unit 127 determines whether or not the recommended cleaning time is within a predetermined period t_{C} from the present. Here, the predetermined period t_{C} is received by the HMI 160 as part of the initial conditions or the like. In the case where it is within the predetermined period t_{C}, the recommended cleaning time deriving unit 127 outputs, to the cooling pipe fouling degree display data generator 133, information indicating that the recommended cleaning time is within the predetermined period t_{C} from the present. The cooling pipe fouling degree display data generator 133 generates image data for this information that is to be displayed by the HMI 160.

The verification calculator 128 verifies the calculation up to the calculation of the fouling degree ξ of the inner and outer surfaces of the cooling pipe 16a of the power generator cooler 16. For this purpose, it compares measured values and the calculation results regarding the major parameters. Based on the result, a calculation model can be adjusted.

The image data generator 130 creates image data for an image to be displayed by the HMI 160. The image data generator 130 has an initial operation image data generator 131, a calculation-target state quantity identification screen data generator 132, the cooling pipe fouling degree display data generator 133, and a verification result display data generator 134.

The initial operation image data generator 131 creates initial operation image data for an image for the identification of a state quantity acquisition case, an image for the setting of a display condition, and so on that are to be displayed by the HMI 160.

The calculation-target state quantity identification screen data generator 132 creates screen data for the identification of the calculation-target state quantity, that is to be displayed by the HMI 160.

The cooling pipe fouling degree display data generator 133 creates data for an image showing a time change of the fouling degree & of the inner and outer surfaces of the cooling pipe 16a of the power generator cooler 16, that is to be displayed by the HMI 160.

The verification result display data generator 134 creates image data for an image showing the measured values and the calculation results regarding the major parameters, as the result of the verification that the verification calculator 128 performed regarding the calculations up to the calculation of the fouling degree ξ of the inner and outer surfaces of the cooling pipe 16a of the power generator cooler 16.

The storage 140 has a measured value storage 141, a pre-obtained data storage 142, a state quantity calculated value storage 143, a cooling pipe fouling degree calculated value storage 144, a display parameter storage 145, and a verification calculation result storage 146.

The measured value storage 141 stores and retains a set of the time when each state quantity being the measured value received by the input unit 110 is received, and the electric power value. Further, the measured value storage 141 stores and retains the time average values of these state quantities calculated by the average value and others calculator 122.

The pre-obtained data storage 142 stores and retains the pre-obtained data such as the factory test data and the design values received by the input unit 110.

The state quantity calculated value storage 143 stores and retains the calculation-target state quantity calculated by the calculation-target state quantity calculator 123.

The cooling pipe fouling degree calculated value storage 144 stores and retains the calculation result including the cooling pipe fouling degree ξ calculated by the cooler characteristic calculator 125. These pieces of information function as past fouling degree-related information. Here, the cooling pipe fouling degree ξ is an index of the fouling of the inner and outer surfaces including the fin of the cooling pipe 16a of the power generator cooler 16.

The display parameter storage 145 stores and retains the display parameters received as the external inputs by the HMI 160.

The verification calculation result storage 146 stores and retains the calculation results by the verification calculator 128 and the measured values of the corresponding parameters.

The determination controller 150 controls the progress of the processing by the power generator cooler performance monitoring device 100 and also performs determination necessary for the progress.

The human machine interface (HMI) 160 has a display part for displaying the images necessary for the monitoring by the power generator cooler performance monitoring device 100, which are generated by the image data generator 130, and also receives, from an external part, parameters in the monitoring including image display.

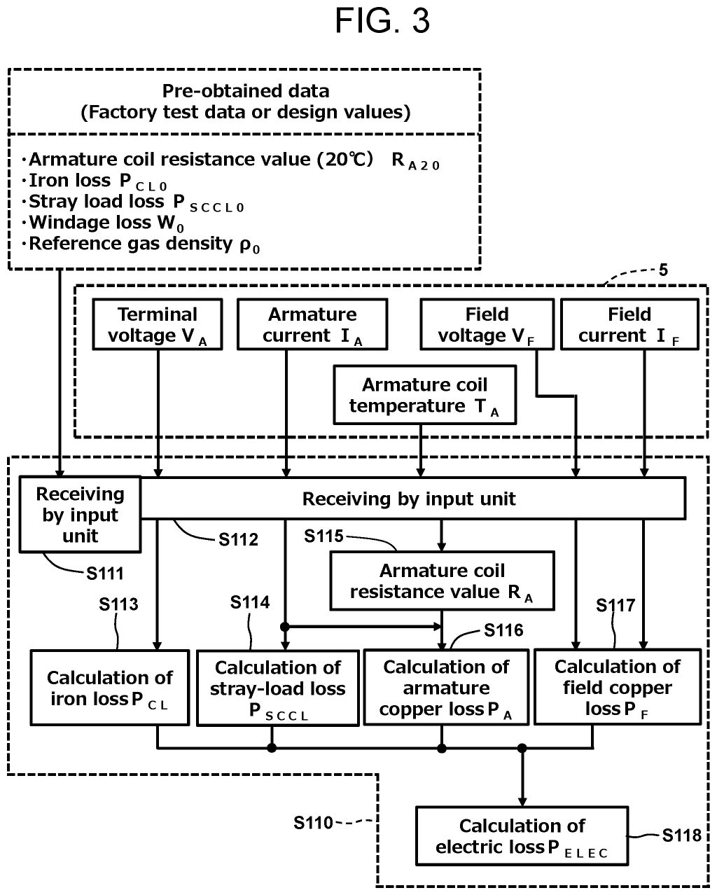

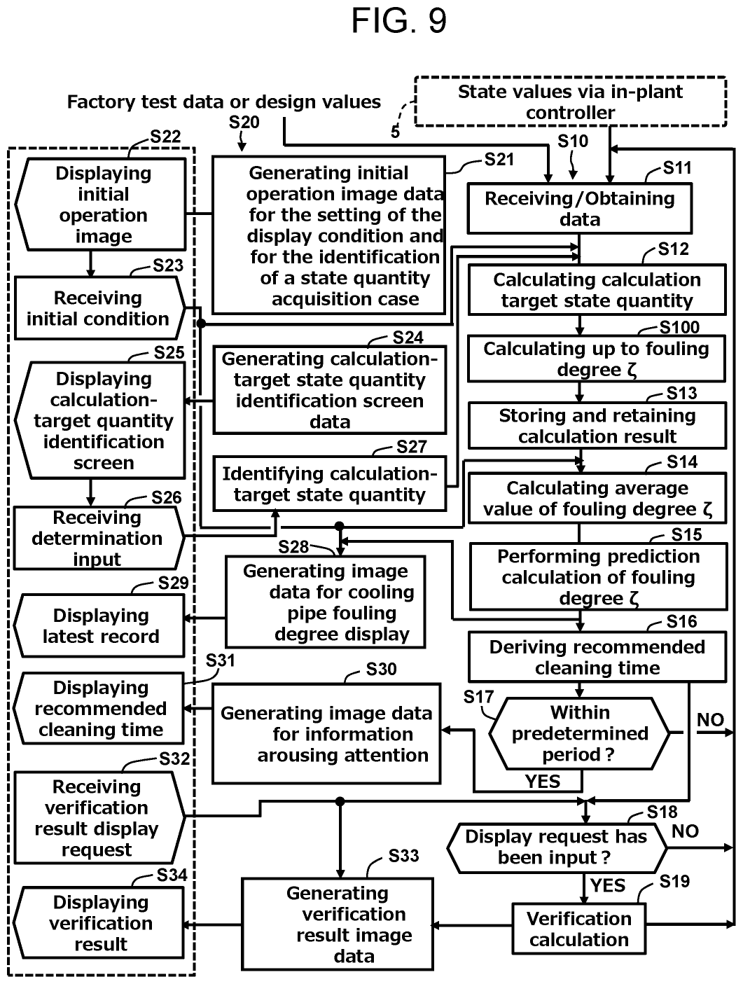

Here, details of the calculations up to the calculation of the fouling degree ξ of the inner and outer surfaces of the cooling pipe 16a by the calculation part 120 will be first described with reference to FIG. 3 to FIG. 5. The contents of this correspond to an calculation step S100 by the calculation part 120 in the procedure of the power generator cooler performance monitoring method which will be described later with reference to FIG. 9. The calculation step S100 by the calculation part 120 has an calculation step S110 by the loss and internal gas state quantity calculator 124, an calculation step S120 by the loss and internal gas state quantity calculator 124, and an calculation step S130 by the cooler characteristic calculator 125.

FIG. 3 is a first flowchart illustrating a detailed flow of the calculation step S110 by the loss and internal gas state quantity calculator 124 of the power generator cooler performance monitoring device according to the embodiment.

First, the input unit 110 receives, as external inputs, an armature coil resistance value R_{A20} at 20° C., an iron loss P_{CL0} as a reference value, a stray-load loss P_{SCCL0} as a reference value, a windage loss W₀ as a reference value, and a reference gas density ρ₀ as a reference value, which are the pre-obtained data such as the factory test data or the design values, and obtains them (step S111).

Next, the input unit 110 receives and obtains, from the in-plant controller 5, measured values of a terminal voltage V_{A} which is a voltage applied to the armature coil 14b, an armature current I_{A} which is a current flowing in the armature coil 14b, an armature coil temperature T_{A} which is the temperature of the armature coil 14b, a field voltage V_{F} which is a voltage applied to the field coil 11c, and a field current IF which is a current flowing in the field coil 11c (step S112).

Next, the loss and internal gas state quantity calculator 124 performs the following calculations to finally calculate an electrical loss PELEC which is the sum value of an iron loss, a copper loss, and a stray loss.

(1) The iron loss PCL is calculated as an nth-order function of the terminal voltage V_{A}. Here, the iron loss P_{CL0} is found as the nth-order function, for example, a quartic function or the like, of the terminal voltage in advance, based on the factory test value or the design value, and the value of the iron loss P_{CL} is calculated from the measured terminal voltage V_{A} (step S113).

(2) A value of a rated stray-load loss P_{SCCL0} found from the factory test value or the design value is corrected by a square ratio of the armature current I_{A}, whereby a stray-load loss P_{SCCL} is calculated (step S114).

(3) The dependence of an armature coil resistance value RA on the armature coil temperature T_{A} is obtained in advance and the armature coil resistance value RA is calculated from the armature coil temperature T_{A}(step S115). Next, an armature copper loss PA is calculated from the armature coil resistance value RA and the armature current I_{A} (step S116).

(4) A field copper loss P_{F} is calculated from the field voltage V_{F} and the field current IF (step S117).

(5) The electrical loss P_{ELEC} is calculated as the sum value of the iron loss P_{CL}, the stray load loss P_{SCCL}, the armature copper loss P_{A}, and the field copper loss P_{F} which are calculated in step S113 to step S117 (step S118).

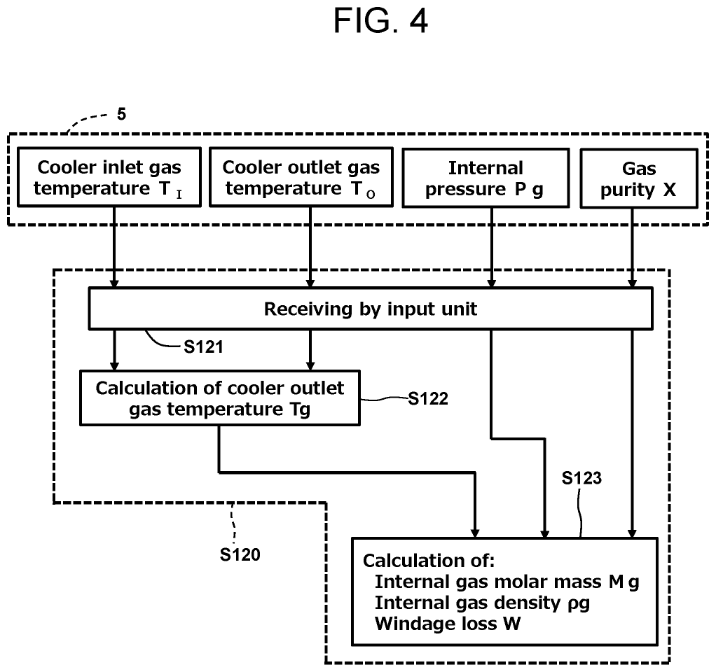

FIG. 4 is a second flowchart illustrating a detailed flow of the calculation step S120 by the loss and interior gas state quantity calculator 124 of the power generator cooler performance monitoring device according to the embodiment.

First, the input unit 110 receives a cooler inlet gas temperature Trand a cooler outlet gas temperature T_{O} which are gas temperatures at an inlet and an outlet of the casing 16b of the power generator cooler 16 respectively, an internal pressure Pg which is the pressure of the cooling gas such as hydrogen in the frame 17, and a gas purity X which is the purity of the cooling gas (step S121).

Next, the loss and internal gas state quantity calculator 124 calculates an internal gas temperature Tg from the cooler inlet gas temperature T_{I} and the cooler outlet gas temperature T_{O} (step S122).

Next, the loss and internal gas state quantity calculator 124 calculates an internal gas molar mass Mg, an internal gas density ρg, and a windage loss W from the internal gas temperature Tg, the internal pressure Pg, and the gas purity X (step S123).

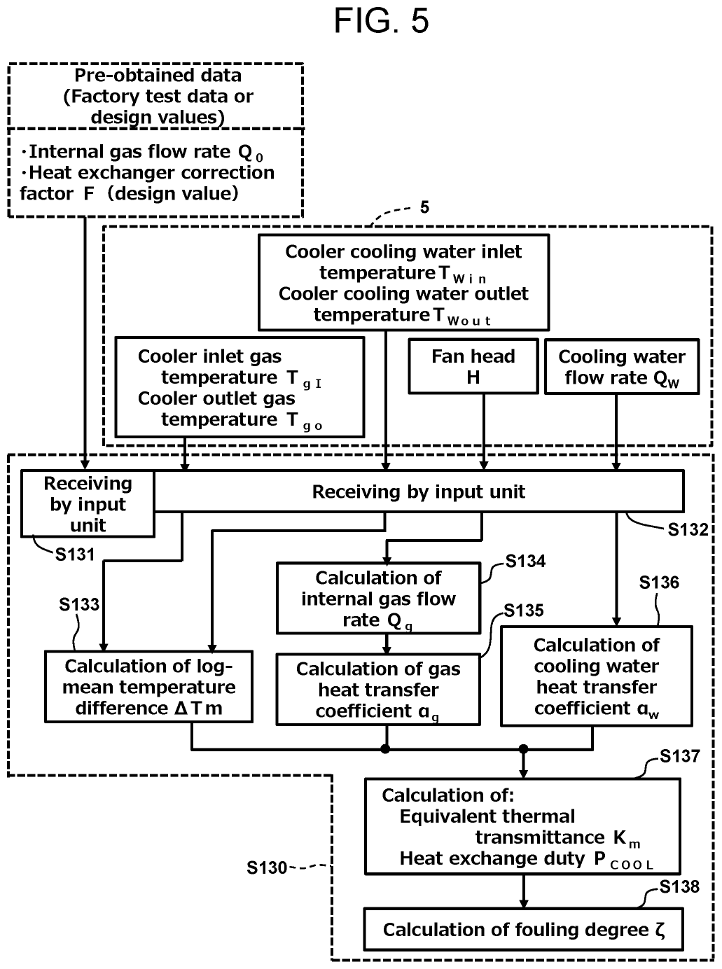

FIG. 5 is a flowchart illustrating a detailed flow of the calculation step S130 by the cooler characteristic calculator 125 of the power generator cooler performance monitoring device 100 according to the embodiment.

First, as external inputs, the input unit 110 receives and obtains an internal gas flow rate Qo as a reference value and a heat exchanger correction factor F as a design value which are the pre-obtained data such as the factory test data or the design value (step S131).

Next, the input unit 110 receives and obtains, from the in-plant controller 5, measured values of a cooler inlet gas temperature Tg_{I} and a cooler outlet gas temperature Tg_{O} which are gas temperatures at the inlet and the outlet of the casing 16b of the power generator cooler 16 respectively, a cooler cooling water inlet temperature T_{win} and a cooler cooling water outlet temperature T_{wout} which are cooling water temperatures at an inlet and an outlet of the cooling pipe 16a of the power generator cooler 16 respectively, a fan head H, and a cooling water flow rate Qw which is the flow rate of the cooling water flowing in the cooling pipe 16a of the power generator cooler 16 (step S132).

Next, the cooler characteristic calculator 125 performs the following calculations to finally calculate the fouling degree & of the inner and outer surfaces of the cooling pipe 16a of the power generator cooler 16.

(1) A log-mean temperature difference ΔTm is calculated from the cooler inlet gas temperature Tg_{I}, the cooler outlet gas temperature Tg_{O}, the cooler inlet cooling water temperature T_{win}, and the cooler outlet cooling water temperature T_{Wout} (step S133).

(2) An internal gas flow rate Qg which is the flow rate of the internal cooling gas is calculated from the measured value of the fan head H (step S134). Next, the velocity of the cooling gas flowing on the outer side of the cooling pipe 16a of the power generator cooler 16 is calculated from the internal gas flow rate Qg, and based on this, a gas heat transfer coefficient ag which is a heat transfer coefficient of the outer surface of the cooling pipe 16a is calculated (step S135).

(3) The velocity of the cooling water flowing in the cooling pipe 16a of the power generator cooler 16 is calculated from the cooling water flow rate Qw, and based on this, a cooling water heat transfer coefficient αw which is a heat transfer coefficient of the inner surface of the cooling pipe 16a is calculated (step S136).

Using the results of step S134 to step S136 and the heat exchanger correction factor F which is read as the pre-obtained data, the equivalent thermal transmittance Km of the power generator cooler 16 and the heat exchange duty P_{COOL} of the power generator cooler 16 are calculated (step S137). Here, the equivalent thermal transmittance Km and the heat exchange duty P_{COOL} are expressed by the following formula (1) and formula (2) respectively.

$$Km = 1 / [ ( 1 / {a}_{g} ) + ( {r}_{1} / {K}_{TUBE} ) + ( {r}_{2} / {a}_{w} ) ] , \qquad ( 1 )$$

where K_{TUBE} is a tube fin equivalent thermal transmittance design value (W/(m²K)), a_{g} is the cooling gas heat transfer coefficient (W/(m²K)), aw is the cooling water heat transfer coefficient (W/(m²K)), r₁ is a cooling pipe heat transfer area correction factor, and r₂ is a cooling pipe inner surface heat transfer area correction factor.

$${P}_{COOL} = Km \cdot F \cdot Δ Tm , \qquad ( 2 )$$

where F is a correction factor (m²), which may be set as F=1 or empirically set to a value according to the type, size, and so on of the power generator cooler.

Next, the fouling degree ξ of the inner surface of the cooling pipe 16a is calculated (step S138).

First, a gas cooler input heat amount P_{LOSS} (W) is calculated by the following formula (3),

$${P}_{LOSS} = {P}_{ELEC} + W , \qquad ( 3 )$$

where P_{ELEC} is the electrical loss P_{ELEC} calculated in step S118, and W is the windage loss W calculated in step S123.

The fouling degree ξ of the inner surface of the cooling pipe 16a is found by the following formula (4).

$$ζ = {P}_{COOL} / {P}_{LOSS} \qquad ( 4 )$$

Specifically, in the case where the heat removed by the power generator cooler 16 (gas cooler input heat amount P_{LOSS}) is equal to the heat exchange duty P_{COOL} of the power generator cooler 16 calculated by the formula (2) assuming that the inner surface of the cooling pipe 16a has no fouling, the fouling degree ξ is 1. On the other hand, in the case where the inner surface of the cooling pipe 16a has fouling, the fouling degree & of the inner surface of the cooling pipe 16a calculated by the above formula (4) is a value larger than 1.

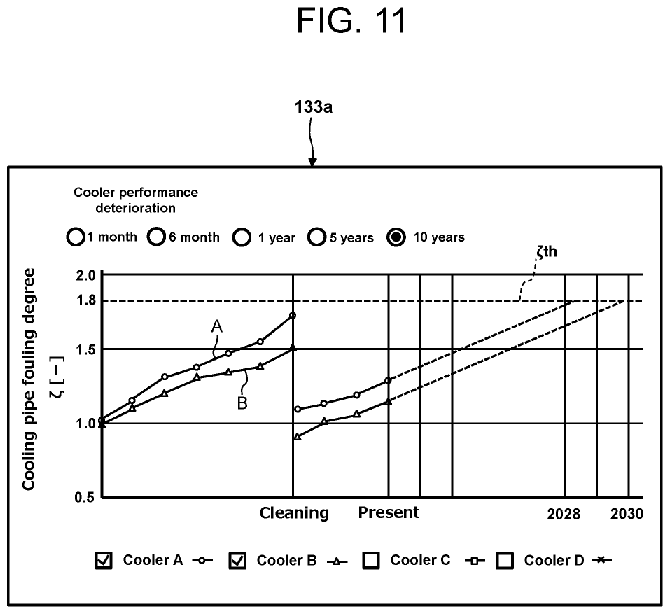

Note that there are a measurement error and errors other than the measurement error, such as an error of the correction factor F in the calculation formula of the heat exchange duty P_{COOL}. Therefore, theoretically, the fouling degree ξ in the fouling-free state is 1, but actually, the calculated fouling degree ξ may be, for example, less than 1 instead of 1. FIG. 11 to be shown later illustrates an example of the case where the fouling degree of Cooler B after it is cleaned is displayed as smaller than 1.

Note that, though the case where the fouling degree ξ is calculated by the formula (3) and formula (4) is described here as an example, this is not restrictive and another inferring method may be used.

The details of the calculations up to the calculation of the fouling degree & by the calculation part 120 in step S100 (step S110 to step S130) are as described above.

Next, the calculation of an inferred value which serves as an alternative to the measured value in the case where the measured data cannot be obtained through the in-plant controller 5 will be described. Since in some plants, it may not be possible to obtain the measured data illustrated in FIG. 3 to FIG. 5 through the in-plant controller 5, it is necessary to identify a calculation-target state quantity and calculate its inferred value serving as an alternative to its measured value.

FIG. 6 to FIG. 8 are first to third charts illustrating an example of a calculation-target state quantity identification screen 132a for the identification of the calculation-target state quantity in the method of the power generator cooler performance monitoring device according to the embodiment. Here, since the calculation-target state quantity identification screen 132a cannot be illustrated in one chart, it is illustrated in the separated three charts for convenience′ sake. However, on the screen, it may be displayed as one chart.

The flow illustrated in FIG. 6 to FIG. 8 is a flow for determination, identification, and calculation method decision by the calculation-target state quantity identifying unit 121, and a calculation method is decided according to the determination. Based on this, the calculation-target state quantity calculator 123 calculates the identified calculation-target state quantity.

At this time, for the progress of the flow, it is necessary to input “YES” or “NO” for each determination item that is reached as the flow proceeds. The flow illustrated in FIG. 6 to FIG. 8 is the calculation-target state quantity identification screen 132a for calculation-target quantity identification that the calculation-target state quantity identification screen data generator 132 causes the HMI 160 to display. Note that the reference signs in FIG. 6 to FIG. 8 are for the explanation and are not displayed on the screen.

That is, in the determination steps in the flow illustrated in FIG. 6 to FIG. 8, YES or NO is decided according to the contents of external inputs. Based on the external inputs, the calculation-target state quantity identifying unit 121 determines a flow and decides the calculation-target state quantity and its calculation method.

Note that the image may be an image in which, in the flowchart illustrating the flow illustrated in FIG. 6 to FIG. 8, options “YES” and “NO” are displayed on a display part of the reached determination step so that either of these can be selected. Further, if substantially the same information can be input, the image may be of a type in which one whose measured value is present is selected from a list, instead of the flowchart illustrated in FIG. 6 to FIG. 8.

As illustrated in FIG. 6 to FIG. 8, the flow proceeds as follows.

First, the calculation-target state quantity identifying unit 121 determines whether a fan head measured value is present or not (step S141). Here, the determination by the calculation-target state quantity identifying unit 121 is based on the external input received by the HMI 160 as described above. The same applies to the below.

In the case where the calculation-target state quantity identifying unit 121 determines that the fan head measured value is present (step S141 YES), the calculation-target state quantity identifying unit 121 decides to calculate an air flow rate and a windage loss from the fan head measured value (step S142). In the case where the calculation-target state quantity identifying unit 121 determines that the fan head measured value is not present (step S141 NO), the calculation-target state quantity identifying unit 121 decides to calculate the air flow rate and the windage loss by a caloric method (step S143).

Next, the calculation-target state quantity identifying unit 121 determines whether a cooling water flow rate measured value is present or not (step S144). In the case where the calculation-target state quantity identifying unit 121 determines that the cooling water flow rate measured value is present (step S144 YES), the calculation-target state quantity identifying unit 121 determines whether a cooling water temperature measured value is present or not (step S145). In the case where the calculation-target state quantity identifying unit 121 determines that the cooling water temperature measured value is present (step S145 YES), the calculation of the fouling degree ξ and so on of the cooling pipe 16a in step S130 illustrated in FIG. 5 is performed.

In the case where the calculation-target state quantity identifying unit 121 determines that the cooling water temperature measured value is not present (step S145 NO), the calculation-target state quantity identifying unit 121 determines whether a cooling water inlet temperature measured value is present or not (step S147).

In the case where the calculation-target state quantity identifying unit 121 determines that the cooling water inlet temperature measured value is present (step S147 YES), the calculation-target state quantity identifying unit 121 decides to calculate a cooling water outlet temperature by the caloric method (step S148).

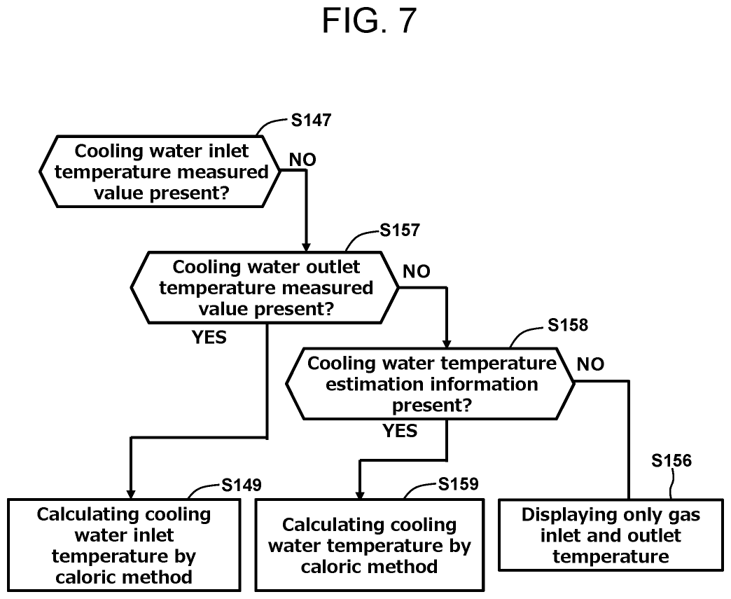

In the case where the calculation-target state quantity identifying unit 121 determines that the cooling water inlet temperature measured value is not present (step S147 NO), the calculation-target state quantity identifying unit 121 first determines whether the cooling water outlet temperature measured value is present or not (step S157) as illustrated in FIG. 7. In the case where the calculation-target state quantity identifying unit 121 determines that the cooling water outlet temperature measured value is present (step S157 YES), it decides to calculate the cooling water inlet temperature by the caloric method (step S149).

In the case where the calculation-target state quantity identifying unit 121 determines in step S157 that the cooling water outlet temperature measured value is not present (step S157 NO), the calculation-target state quantity identifying unit 121 determines whether cooling water temperature estimation information is present or not (step S158). In the case where the calculation-target state quantity identifying unit 121 determines that the cooling water temperature estimation information is present (step S158 YES), it decides to calculate the cooling water temperature by the caloric method (step S159). In the case where the calculation-target state quantity identifying unit 121 determines that the cooling water temperature estimation information is not present (step S158 NO), only the gas inlet outlet temperatures are displayed (step S156).

In the case where the calculation-target state quantity identifying unit 121 determines in step S144 that the cooling water flow rate measured value is not present (step S144 NO), the calculation-target state quantity identifying unit 121 determines whether the cooling water temperature measured value is present or not (step S150) as shown in FIG. 6.

In the case where the calculation-target state quantity identifying unit 121 determines that the cooling water inlet temperature measured value is present (step S150 YES), the calculation-target state quantity identifying unit 121 determines whether the cooling water outlet temperature measured value is present or not (step S152). In the case where the calculation-target state quantity identifying unit 121 determines that the cooling water outlet temperature measured value is present (step 152 YES), the calculation-target state quantity identifying unit 121 decides to calculate the cooling water flow rate by the caloric method (step S151). Thereafter, the calculation of the fouling degree and so on in step S130 is performed.

On the other hand, in the case where the calculation-target state quantity identifying unit 121 determines that the cooling water inlet temperature measured value is not present (step S150 NO), the calculation-target state quantity identifying unit 121 determines whether a cooling water outlet temperature measured value is present or not (step S153).

In the case where the calculation-target state quantity identifying unit 121 determines that the cooling water outlet temperature measured value is present (step S153 YES), the calculation-target state quantity identifying unit 121 determines whether cooling water flow rate estimation information is present (step S154). Here, the cooling water flow rate estimation information is, for example, an opening degree of a cooling water temperature control valve (not illustrated). On the other hand, in the case where the calculation-target state quantity identifying unit 121 determines that the cooling water inlet temperature measured value is not present (step S152 NO), the calculation-target state quantity identifying unit 121 similarly determines whether the cooling water flow rate estimation information value is present or not (step S154).

In the case where the calculation-target state quantity identifying unit 121 determines that the cooling water flow rate estimation information is present (step S154 YES), the cooling water flow rate and the cooling water temperature are calculated (step S155). Thereafter, the calculation of the fouling degree and so on in step S130 is performed.

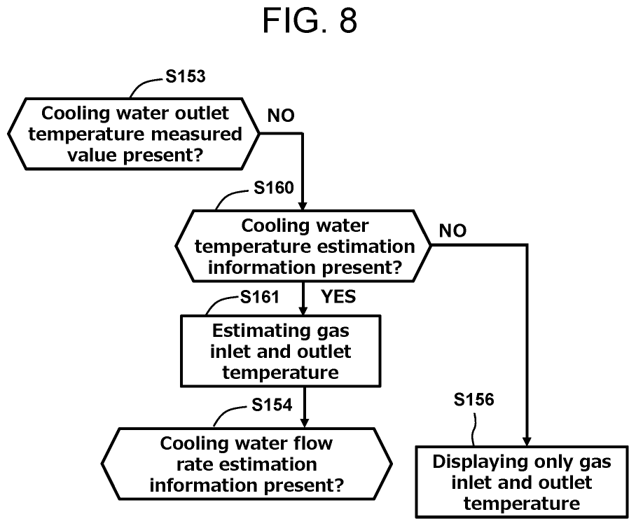

In the case where the calculation-target state quantity identifying unit 121 determines in step S153 that the cooling water outlet temperature measured value is not present (step S153 NO), the calculation-target state quantity identifying unit 121 determines whether cooling water temperature estimation information is present or not (step S160) as illustrated in FIG. 8. In the case where it is determined in step S160 that the cooling water temperature estimation information is present (step S160 YES), the calculation-target state quantity calculator 123 performs estimation calculation of a gas inlet or gas outlet temperature (step S161), and next the flow goes to the aforesaid determination in step S154. On the other hand, in the case where it is determined in step S160 that the cooling water temperature estimation information is not present (step S160 NO), only the gas inlet outlet temperatures are displayed (step S156).

In the case where the calculation-target state quantity identifying unit 121 determines in step S154 that the cooling water flow rate estimation information is not present (step S154 NO), the flow does not go to the calculation of the fouling degree ξ and so on in step S130 but, for example, only the gas inlet temperature and the gas outlet temperature are displayed by the HMI 160 (step S156). In this case, a warning to the effect that there is not sufficient information necessary for the calculation of the fouling degree ξ may be displayed by the HMI 160.

As described above, based on the results of the identification of the calculation-target state quantity and the decision of the method to calculate it by the calculation-target state quantity identifying unit 121, the calculation-target state quantity calculator 123 calculates the calculation-target state quantity.

For example, in the case where it is determined in step S141 in FIG. 6 that the operation data that can be obtained from the in-plant controller 5 does not include the measured value of the fan head H (step S141 NO), the air flow rate Qg of the cooling gas is calculated using, for example, the following formula (5),

$$Qg = {P}_{LOSS} / [ ( {C}_{P g} \cdot ρ g ) ( {T}_{gin} - {T}_{gout} ) ] , \qquad ( 5 )$$

where P_{LOSS} is a gas cooler input heat amount (W), C_{pg} is gas specific heat (J/kg·K), ρg is gas density (kg/m³), T_{gin} is cooler inlet gas temperature (° C.), and T_{gout} is cooler outlet gas temperature (° C.).

FIG. 9 is a flowchart illustrating the flow of a process by the power generator cooler performance monitoring device according to the embodiment.

The flow of the process by the power generator cooler performance monitoring device is roughly composed of step S10 of data processing up to the calculation of the performance of the power generator by the power generator cooler performance monitoring device 100 and step S20 involved in the display for power generator cooler performance monitoring by the power generator cooler performance monitoring device 100.

First, the flow of the data processing up to the calculation of the performance of the power generator by the power generator cooler performance monitoring device 100 will be described.

The input unit 110 receives and obtains the state quantities and the pre-obtained data of the power generator 10 through the in-plant controller 5 (step S11).

Next, the calculation-target state quantity is calculated (step S12). Specifically, based on a specific result of the identification of the calculation-target state quantity which result is obtained in later-described step S27 of step 20, the calculation-target state quantity is calculated according to the above-described flow in FIG. 6.

Next, the calculation part 120 performs the calculations up to the calculation of the cooling pipe fouling degree ξ (step S100). For more details, the contents previously described with reference to FIG. 3 to FIG. 5 can be referred to.

Next, as illustrated in FIG. 9, the storage 140 stores and retains the calculation results (step S13). In more detail, the cooling pipe fouling degree calculated value storage 144 stores and retains the fouling degree ξ calculated in step S100 and the calculation results obtained in the steps before this.

Next, average values of the fouling degree ξ and so on are calculated (step S14). Specifically, the average value and others calculator 122 calculates a moving average of a predetermined number N of the calculation results of the fouling degree ξ and so on stored in the cooling pipe fouling degree calculated value storage 144. Note that the predetermined number N is received from an external part in later-described step S23 of receiving an initial condition and so on.

Next, the prediction calculator 126 performs a prediction calculation of the fouling degree ξ (step S15). Specifically, based on the information on the fouling degrees ξ stored in the cooling pipe fouling degree calculated value storage 144, future fouling degrees ξ and future values of the fouling degree ξ under the maximum increase rate in a predetermined past period are calculated.

Next, the recommended cleaning time deriving unit 127 derives a recommended cleaning time and determines whether or not it is within a predetermined period t_{C} (step S17). Here, the predetermined period t_{C} is a period that is set based on a period required for performing items that need to be performed in advance, such as the securing of a budget for the cleaning in a regular inspection or the like, process adjustment in the regular inspection, the adjustment of a workplace, and personnel preparation. Note that a longer allowance may be taken. The predetermined period t_{C} is received as part of the initial condition and so on by the HMI 160.

In the case where the recommended cleaning time deriving unit 127 determines that the recommended cleaning time is within the predetermined period t_{C} (step S17 YES), information to this effect is output to the cooling pipe fouling degree display data generator 133. In the case where the recommended cleaning time deriving unit 127 does not determine that the recommended cleaning time is within the predetermined period t_{C} (step S17 NO), the flow returns to step S11.

Further, after step S16, the determination controller 150 determines whether or not a display request for the verification result has been input to the HMI 160, in parallel to step S17, or before or after step S17 (step S18). In the case where the determination controller 150 determines that the display request for the verification result has not been input (step S18 NO), the flow returns to step S11.

In the case where the determination controller 150 determines that the display request for the verification result has been input (step S18 YES), the verification calculator 128 performs a verification calculation (step S19) and the flow returns to step S11. This is the flow in step S10 of the data processing up to the calculation of the performance of the power generator by the power generator cooler performance monitoring device 100.

Next, details of step S20 involved in the display for the power generator cooler performance monitoring by the power generator cooler performance monitoring device 100 will be described below.

First, the initial operation image data generator 131 of the image data generator 130 generates image data for initial operation that is to be displayed by the HMI 160 (step S21). Specifically, the initial operation image data generator 131 generates initial operation image data for the setting of the display condition and for the identification of a state quantity acquisition case, which is to be displayed by the HMI 160. Based on this, the HMI 160 displays an initial operation image (step S22).

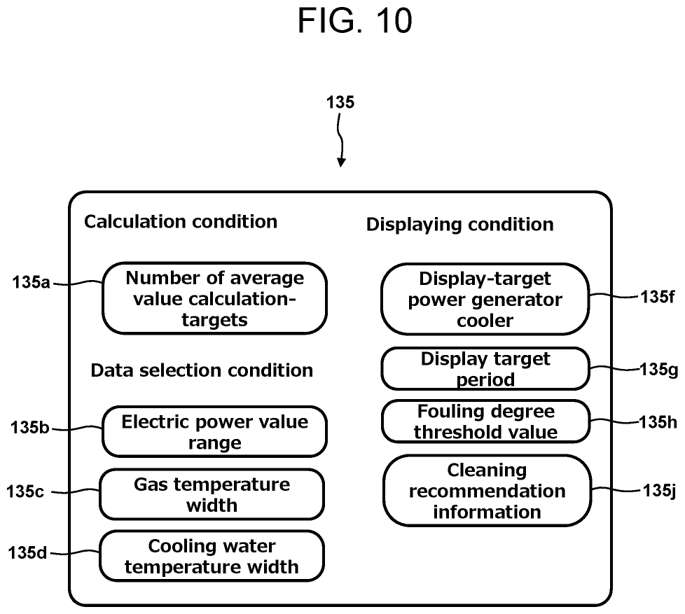

FIG. 10 is a screen view illustrating an example of the initial operation image 135 that is to be displayed by the HMI 160 of the power generator cooler performance monitoring device 100 according to the embodiment. In the description below, a case where icons are displayed is taken as an example, but they may be hardware bottoms or the like if the same operation can be executed.

On the initial operation image 135, icons involved in an calculation condition, a data selection condition, and a display condition are displayed.

As the calculation condition on the initial operation image 135, an icon 135a of “number of average value calculation-targets” is displayed. In response to the clicking of the icon 135a of “number of average value calculation-targets”, options “time width” and “number of times” are displayed in a pull-down menu. When “number of times” is selected, the number N of averaging targets can be directly input. When “time width” is selected, 10 minutes or the like can be input, for instance. The average value and others calculator 122 calculates the number N of averaging targets from the time interval Δt.

As the data selection condition on the initial operation image 135, an icon 135b of “electric power value range”, an icon 135c of “gas temperature width”, and an icon 13d of “cooling water temperature width” are displayed.

In response to the selection of the icon 135b of “electric power value range”, an input window of (xx) to (yy) is displayed with an MVA unit and an MW unit. As these (xx) and (yy), the minimum value and the maximum value are input respectively so that an electric power width can be designated. This is intended to exclude a low-power region because accuracy in the derivation of the fouling degree ξ becomes worse if the electric power is low.

In response to the selection of the icon 135c of “gas temperature width”, an input window of “(xx) to (yy)” is displayed with a ° C. unit. The minimum value and the maximum value are input as these (xx) and (yy) respectively so that the gas temperature width can be designated. Further, in response to the selection of the icon 135d of “cooling water temperature width”, an input window of (xx) to (yy) is displayed with a ° C. unit. The minimum value and the maximum value are input as (xx) and (yy) respectively so that the cooling water temperature width can be designated. This is intended to exclude data with a large variation width because the accuracy in the derivation of the fouling degree becomes worse if the gas temperature width and the cooling water temperature width are too large.

As the display condition on the initial operation image 135, an icon 135f of “display-target power generator cooler” and an icon 135g of “display-target period” are displayed.

In response to the selection of the icon 135f of “display-target power generator cooler”, the names of options, for example, Cooler A, Cooler B, Cooler C, and Cooler D and selection columns are displayed in a pull-down menu. Here, one display target or more can be selected.

In response to the selection of the icon 135g of “display-target period”, options in a month unit and a year unit are displayed in a pull-down menu. When one of these is selected, an input window is displayed. For example, when “5 years” is input, past five-year record and prediction for future five years from the present are displayed on the time base, as illustrated in FIG. 11 which will be referred to later.

In response to the selection of an icon 135h of “fouling degree threshold value”, an input window is displayed so that a fouling degree threshold value can be input. Here, the fouling degree threshold value is a level of the fouling degree & indicating that when the fouling degree ξ derived by the calculation part 120 reaches this threshold value, it is necessary and recommended to clean the cooling pipe 16a by opening the power generator cooler 16.

In response to the selection of the icon 135h of “fouling degree threshold value”, an input window is displayed so that the fouling degree threshold value ξth can be input. Here, the fouling degree threshold value ξth is a level of the fouling degree ξ indicating that when the fouling degree ξ derived by the calculation part 120 reaches this threshold value ξth, it is necessary and recommended to clean the cooling pipe 16a by opening the power generator cooler 16. Note that, though the case where the fouling degree threshold value ξth is an external input is shown, it may be stored as a fixed value in, for example, the recommended cleaning time deriving unit 127 or the storage 140.

When a power generator is disassembled at the time of a regular inspection of a plant, there may arise a necessity for changing the fouling degree threshold value ξth due to a change of the condition in facility other than the power generator cooler 16, such as a cooling water system or a final heat release destination, for instance. In this case, a method of setting the cleaning time of the power generator cooler 16 based on an absolute value of the cooler fouling degree, a method of setting a fouling degree in a certain period after the cleaning as a reference value and setting the cleaning time based on a relative value (for example, 1.8 times or the like) to this reference value, or the like may be employed.

An icon 135j of “cleaning recommendation information” is involved in the display on a later-described latest record image 133a (FIG. 11). In response to the selection of the icon 135j of “cleaning recommendation information”, an input window of, for example, the number of operation cycles is displayed as the predetermined period t_{C}, with, for example, “( ) operation cycles”. Here, for example, in the case where “4 operation cycles” is input, the recommended cleaning time is displayed on the latest record image 133a at a point in time four-operation cycles before a point in time when the fouling degree ξ derived by the calculation part 120 exceeds the fouling degree threshold value.

Note that the initial operation image 135 illustrated in FIG. 10 is presented by way of example, and it may be an image of any other type as long as substantially the same input can be made. Further, out of the items in the initial operation image 135, some item may be moved into another image if providing it in the other image increases operability, or it may be provided on both so that the input can be made on both.

Further, the items other than the display condition may be only for a designer of the power generator cooler performance monitoring device 100, or part of the display condition may also be only for the designer. In this manner, different initial operation images 135 may be provided for the designer of the power generator cooler performance monitoring device 100 and for a user such as a monitoring worker using the power generator cooler performance monitoring device 100. In such a case, the initial operation image 135 illustrated in FIG. 10 is used as the initial operation image for the designer.

Next, the HMI 160 receives the initial condition and so on that are obtained through operation or input based on the initial operation image 135 (step S23).

After the initial condition and so on are received, the calculation-target state quantity identification screen data generator 132 creates screen data for the identification of a calculation-target state quantity, that is to be displayed by the HMI 160.

Next, the calculation-target state quantity identification screen data generator 132 generates calculation-target state quantity identification screen data (step S24), and based on this, the HMI 160 displays the calculation-target quantity identification screen 132a (step S25). Next, the HMI 160 receives determination inputs (step S26), and according to the flow illustrated in FIG. 6, the calculation-target state quantity identifying unit 121 identifies the calculation-target state quantity and decides a method to calculate its inferred value that is an alternative to a measured value (step S27). Then, based on the decision, the calculation-target state quantity calculator 123 executes this calculation (step S12).

Next, in the flow illustrated in FIG. 9, based on the results of the calculation of the average values of the fouling degree ξ and so on in step S14 and the calculation for predicting the fouling degree ξ in step S15, the cooling pipe fouling degree display data generator 133 generates image data for cooling pipe fouling degree display, that is to be displayed by the HMI 160 (step S28). The HMI displays the cooling pipe fouling degree as a latest record (Step S29).

FIG. 11 is a screen view illustrating an example of the latest record image 133a displayed on the HMI 160 of the power generator cooler performance monitoring device according to the embodiment. The latest record image 133a illustrated here is an example of a display image for the monitoring worker of the power station, such as an engineering worker, a maintenance worker, or an operator.

The latest record image 133a has three elements: a graph of a time change of the cooling pipe fouling degree ξ, selection candidates for a power generator cooler, and selection candidates for a display width of a time base of the graph.

The first element is the graph of the time change of the cooling pipe fouling degree ξ and is arranged in the middle of the latest record image 133a. In the graph, the horizontal axis represents the time and the vertical axis represents the cooling pipe fouling degree ξ.

The second element is the display of the selection candidates for the power generator cooler 16 to be displayed and is arranged below the graph in the example in FIG. 11. In the example in FIG. 11, four coolers from Cooler A to Cooler D are displayed. From the displayed options “Cooler A” to “Cooler D”, a power generator cooler 16 desired to be displayed on the graph is selectable. Note that this display may be of a type that receives the input of the sign of the power generator cooler 16 desired to be selected.

The third element is the display of the selection candidates for the display width of the time base of the graph and is arranged above the graph in the example in FIG. 11. In the example in FIG. 11, from the displayed options “1 month”, “6 months”, “1 year”, “5 years”, and “10 years”, one of one month, six months, one year, five years, and ten years is selectable.

On the horizontal axis of the graph as the first element, the present is in the middle, the past record is on the left of the middle, and a future prediction display period is on the right of the middle. For example, if “10 years” is selected, a past 10-year period up to the present is displayed on the left half, and a future ten-year period from the present is displayed on the right half. It should be noted that the position where the “present” is displayed is not limited to the middle on the horizontal axis, and may be set to a desired position on the horizontal axis.

In FIG. 11, Cooler A and Cooler B are selected out of the power generator coolers 16. The time change of the fouling degree ξ of Cooler A is represented by the hollow circular markers and the solid line connecting these, and that of Cooler B is represented by the hollow triangular markers and the solid line connecting these. Further, in the future prediction display period, they are represented by the broken lines. In the case where the plurality of power generator coolers 16 are the display targets as described above, their fouling degrees ξ may be distinguished by the kind of markers as illustrated in FIG. 11, or may be distinguished by the kind of lines such as a solid line, a broken line, and so on, or they may be distinguished by color.

In the graph, the thick broken line representing the fouling degree threshold value ξth is displayed. The line representing the fouling degree threshold value ξth is not limited to the thick broken line but may be displayed with color or in any other form arousing attention.

In the example illustrated in FIG. 11, the time when the cleaning was actually executed is displayed, and after the cleaning, the cooling pipe fouling degree ξ returns to a low value, but since this value can be calculated at a point in time when the operation data can be collected after the inspection of the plant ends and its operation is started, the data display start point after the cleaning is accordingly delayed from the cleaning time. Note that after the cleaning, the fouling degree ξ becomes the value obtained after the cleaning and therefore, its display before the cleaning may be erased. Alternatively, the display may be left for reference for grasping how the fouling degree ξ increases. FIG. 11 illustrates the example where the display is left.

In the case where the recommended cleaning time deriving unit 127 determines in the above-described step S17 that the recommended cleaning time is within the predetermined period t_{C} (step S17 YES), the cooling pipe fouling degree display data generator 133 receiving this information generates image data for information arousing attention to this, that is to be displayed by the HMI 160 (step S30). The HMI 160 displays the information based on this image data (step S31).

In the example illustrated in FIG. 11, the example where the cooling pipe fouling degree ξ is expected to reach the fouling degree threshold value ξth before 2029 in Cooler A and before 2030 in Cooler B is illustrated as an example. Therefore, Cooler A and Cooler B require the cleaning of the cooling pipe in 2028 at the latest and in 2029 at the latest respectively. Therefore, the securing of a budget for the cleaning in a regular inspection or the like, process adjustment in the regular inspection, the adjustment of a workplace, and personnel preparation need to be done in advance. By the time earlier by the preparation period for these than the time by which the cleaning is to be executed at the latest, information to the effect that “preparation for cleaning needs to be started” is displayed on the screen to arouse attention.

Next, in the flow illustrated in FIG. 9, if there is a verification result display request from an external part, the HMI 160 receives this as an external input (step S32).

The determination controller 150 constantly determines whether or not the verification result display request is present (step S18), and in the case where there is no special verification result display request (step S18 NO), the flow returns to step S11.

On the other hand, if the HMI 160 receives the verification result display request as the external input in step S32, the determination controller 150 determines that the verification result display request is present (step S18 YES), instructs the verification calculator 128 to perform a verification calculation, and the verification calculator 128 performs the verification calculation (step S19).

The verification result display data generator 134 creates verification result image data based on the verification result by the verification calculator 128 (step S33), and the HMI 160 displays a verification result image (step S34). Two examples of the verification result image will be shown below.

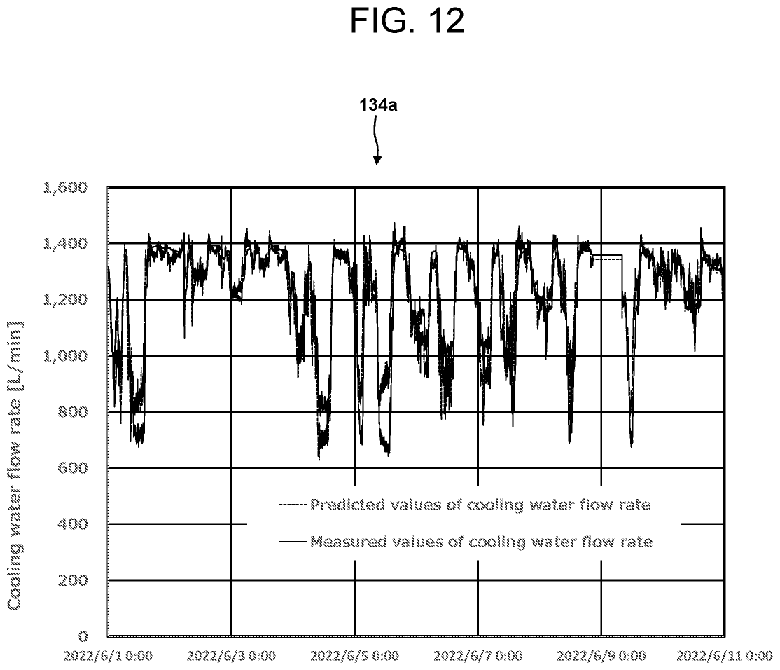

FIG. 12 is a screen view illustrating an example of a first verification result image 134a displayed by the HMI 160 of the power generator cooler performance monitoring device 100 according to the embodiment.

In the first verification result image 134a, the horizontal axis represents time and the vertical axis represents a cooling water flow rate [L/min]. Further, the broken-line curve represents a predicted value of the cooling water flow rate. Further, the solid-line curve represents a measured value of the cooling water flow rate. In the example illustrated in FIG. 12, the predicted value of the cooling water flow rate well agrees with the measured value of the cooling water flow rate.

In the case where the calculation part 120 infers a value of the cooling water flow rate in a plant from which a measured value of the cooling water flow rate cannot be obtained, it is important to check and verify whether a model for this is appropriate. In such a case, it is possible to verify the validity of the model by comparing the predicted value and the measured value of the cooling water flow rate which are illustrated in FIG. 12, using the exemplified plant.

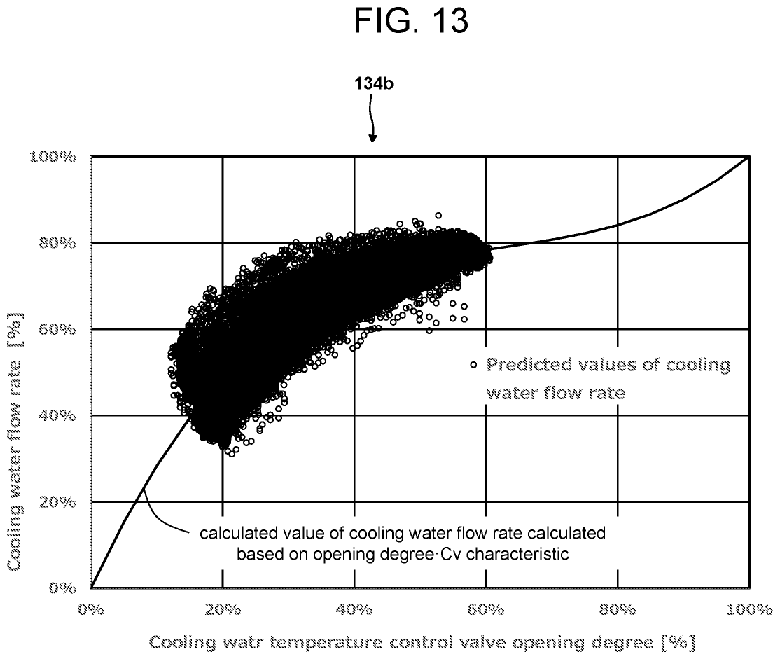

FIG. 13 is a screen view illustrating an example of a second verification result image 134b that is to be displayed by the HMI 160 of the power generator cooler performance monitoring device 100 according to the embodiment.

In the second verification result image 134b, the horizontal axis represents a cooling water temperature control valve opening degree [%] and the vertical axis represents a cooling water flow rate [%]. The solid-line curve represents a calculated value of the cooling water flow rate calculated based on an opening degree Cv characteristic of the cooling water temperature control valve (not illustrated). Further, the hollow-circular markers represent predicted values of the cooling water flow rate. Here, the predicted values of the cooling water flow rate are values calculated by the caloric method, that is, from a thermal balance of the system. In the example illustrated in FIG. 13, the cooling water flow rate calculated based on the opening degree Cv characteristic of the cooling water temperature control valve (not illustrated) well agrees with the cooling water flow rate calculated by the caloric method. Therefore, in the case where there is not sufficient information necessary for any of the methods, it is possible to obtain an appropriate value even if it is calculated by another method.

As illustrated in FIG. 12 and FIG. 13 as examples in the above, the verification calculator 128 performs the calculation of the verification result regarding the designated state quantity, the verification result display data generator 134 generates the display data, and the HMI 160 displays the information. As a result, it is possible to confirm the verification result.

According to the embodiment described hitherto, it is possible to provide a power generator cooler performance monitoring device capable of recognizing, in time series, past-to-present cooling pipe fouling degrees of a power generator cooler, which are calculated based on measured information, and predicted future cooling pipe fouling degrees.

### Other Embodiments

While certain embodiments have been described, these embodiments have been presented by way of example only, and are not intended to limit the scope of the inventions. The features of the embodiments may be combined, and further, the embodiments may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power generator cooler performance monitoring device for a power generator, the device comprising
an image data generator configured to generate display information for displaying:
past fouling degree-related information regarding past-to-present fouling degrees of a power generator cooler cooling pipe from the past to the present calculated based on information regarding the power generator; and
future fouling degree-related information indicating information regarding a future fouling degree of the power generator cooling pipe in the future, based on the past fouling degree-related information.

2. The power generator cooler performance monitoring device according to claim 1,
wherein the image data generator generates the display information for displaying both the past fouling degree-related information and the future fouling degree-related information in time series.

3. The power generator cooler performance monitoring device according to claim 1,
wherein the past fouling degree-related information is used as an average value of a predetermined number of pieces of the past fouling degree-related information or in a predetermined time width including the predetermined number of pieces of the past fouling degree-related information.

4. The power generator cooler performance monitoring device according to claim 3,
wherein the display information is generated based on a data selection condition that is input, and the data selection condition includes one of the predetermined number or the predetermined time width, a power width of the power generator, a width of a gas temperature of the power generator cooler, a width of a cooling water temperature of the power generator cooler.

5. The power generator cooler performance monitoring device according to claim 1,
wherein the future fouling degree-related information is calculated based on a maximum increase rate of the past fouling degree-related information in a period up to a present time.

6. The power generator cooler performance monitoring device according to claim 1,
wherein the image data generator generates the display information for displaying a recommended cleaning time at which it is recommended that cleaning of the power generator cooler be executed, the recommended cleaning time being calculated based on the future fouling degree-related information.

7. The power generator cooler performance monitoring device according to claim 1, the device further comprising:
an input unit configured to receive information including measured state quantities of the power generator and pre-obtained data relating to the power generator; and
an adding calculator, for a case where the measured state quantities and the pre-obtained data are insufficient for calculation of the cooling pipe fouling degree and missing information for the calculation is present, configured to calculate the missing information based on the measured state quantities and the pre-obtained data.
